(19) United States
(12) Patent Application Publication
(10) Pub. No.: US 2021/0170972 A1
(43) Pub. Date: Jun. 10, 2021

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventors: Mitsuyoshi OHNO, Miyoshi-shi (JP); Daiki KUBO, Toyota-shi (JP); Yosuke NOZAKI, Toyota-shi (JP); Tsukasa NAKANISHI, Nagoya-shi (JP); Hironori AOYAMA, Toyota-shi (JP); Seiji YOGO, Nagoya-shi (JP); Tae SUGIMURA, Miyoshi-shi (JP); Yasuhiro KOBATAKE, Nagoya-shi (JP); Takeshi YAMADA, Anjo-shi (JP); Ryo SATO, Nisshin-shi (JP); Sayaka NINOYU, Toyota-cho (JP)

(73) Assignee: TOYOTA JIDOSHA KABUSHIKI KAISHA, Toyota-shi (JP)

(21) Appl. No.: 17/109,767

(22) Filed: Dec. 2, 2020

(30) Foreign Application Priority Data
Dec. 6, 2019 (JP) 2019-221307

(51) Int. Cl. B60R 21/0132; B60W 50/14; B60W 40/08; G05D 1/00

(52) U.S. Cl. CPC B60R 21/0132; B60W 50/14; G05D 2201/0213; G05D 1/0088; B60W 40/08

(57) ABSTRACT

An information processing device that provides information to an occupant who performs a given activity in a vehicle has a controller. The controller predicts an acceleration applied to the vehicle within a predetermined period, gives notice to the occupant when a value related to the predicted acceleration exceeds a threshold value, and determines the threshold value based on a type of the activity performed in the vehicle.

### INCORPORATION BY REFERENCE

The disclosure of Japanese Patent Application No. 2019-221307 filed on Dec. 6, 2019 including the specification, drawings and abstract is incorporated herein by reference in its entirety.

### BACKGROUND

### 1. Technical Field

The disclosure relates to a technology useful when providing services by use of vehicles.

### 2. Description of Related Art

Some attempts are being made to provide services by dispatching autonomous vehicles designed for various purposes or uses. For example, vehicles having different functions are selectively dispatched, in response to a request of a user, so that the user can perform a certain activity while moving.

Also, there is a technology for improving ride comfort, by providing information to an occupant of a vehicle. For example, a vehicle that gives notice to an occupant based on changes in the acceleration (oscillations) is disclosed in Japanese Unexamined Patent Application Publication No. 2005-128631 (JP 2005-128631 A).

### SUMMARY

When the user performs some activity in the vehicle, it is preferable to provide information concerning oscillations of the vehicle, to the user.

This disclosure provides an information processing device, information processing method, and program, which are used when providing information concerning oscillations, to an occupant in a vehicle cabin.

A first aspect of the disclosure is concerned with an information processing device that provides information to an occupant who performs a given activity in a vehicle. The information processing device has a controller configured to predict an acceleration applied to the vehicle within a predetermined period, give notice to the occupant when a value related to the predicted acceleration exceeds a threshold value, and determine the threshold value based on a type of the activity performed in the vehicle.

A second aspect of the disclosure is concerned with an information processing method performed by the information processing device. The information processing method includes the steps of: predicting an acceleration applied to the vehicle within a predetermined period, giving notice to the occupant when a value related to the predicted acceleration exceeds a threshold value, and determining the threshold value based on a type of the activity performed in the vehicle.

Other aspects of the disclosure include a program that causes a computer to execute an information processing method performed by the information processing device, or a computer-readable storage medium that non-temporarily stores the program.

According to the disclosure, it is possible to provide information concerning oscillations to the occupant in the vehicle cabin.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a vehicle system according to a first embodiment;

FIG. 2 is a view showing the overall configuration of the vehicle system;

FIG. 3 is a view showing an example of threshold data stored in a vehicle-mounted device;

FIG. 4 is a view showing input data to a controller and output data from the controller;

FIG. 5 is a view showing the relationship between the acceleration and time;

FIG. 6 is a flowchart illustrating a control routine executed by the vehicle-mounted device;

FIG. 7 is a view showing the configuration of a vehicle-mounted device according to a second embodiment; and

FIG. 8 is a view showing a second example of threshold data stored in the vehicle-mounted device.

### DETAILED DESCRIPTION OF EMBODIMENTS

An information processing device illustrated as one embodiment provides information to an occupant of a vehicle equipped with a space (vehicle cabin) having a certain function. In this embodiment, the vehicle is a mobile object having two or more wheels and power, for example. The vehicle may include a unit that provides power, and a cabin unit, such that the units can be detached from each other. Also, the vehicle may be a self-driving vehicle that is automatically operated under control of an on-board computer.

Among various forms of vehicles, some vehicles that provide a variety of services during traveling may be considered. For example, where the vehicle cabin has a function of an office, the user is able to work while moving. Also, where the vehicle cabin has a function of accommodation, the user is able to move while sleeping at night. Other than these examples, services, such as those of a fitness club and a hair salon, which are not directly related to movement or traveling may be offered in vehicles, so that additional values to movement can be provided.

In the meantime, where various services are provided in vehicles, preparation for oscillations will be needed. For example, when a user does weight training in a vehicle, the user may lose balance if unintended oscillations are generated. Also, where a user performs delicate work, such as a makeup, in a vehicle, the user may get clumsy because of oscillations.

To deal with the above situations, it may be considered to give notice in advance when oscillations of a predetermined magnitude or larger are predicted. However, if a reference value used for giving notice about oscillations is uniformly set, or set to a constant value, some problem may arise; for example, no notice that matches the activity in the vehicle is generated, or, conversely, such notices are frequently generated, which may result in reduction of convenience.

The information processing device according to the embodiment has a controller that executes steps of: predicting an acceleration applied to the vehicle within a predetermined period, giving notice to the occupant when a value related to the predicted acceleration exceeds a threshold value, and determining the threshold value based on the type of the activity performed in the vehicle.

The controller may predict the acceleration applied to the vehicle at a certain point in the future, or may predict chronological change of the acceleration applied to the vehicle. The value related to the acceleration may be the acceleration, or jerk (the rate of change of acceleration). The controller may give notice to the occupant of the vehicle, based on the result of comparison between the result of prediction and the threshold value. The threshold value used at this time is determined based on the type of the activity performed in the vehicle cabin. Thus, the threshold value can be set to a relatively low value when an activity that is sensitive to oscillations is performed in the vehicle, and can be set to a relatively high value in other cases. As a result, the safety and the convenience can be both achieved. The threshold value may be obtained from a storage unit that stores the types of activities and threshold values, such that the type of each activity is associated with a corresponding one of the threshold values.

The vehicle is able to travel with a certain cabin unit joined to the vehicle, and the controller may be characterized by determining the threshold value, based on the type of the occupant's activity performed in the cabin unit joined to the vehicle. Also, the controller may be characterized by determining the threshold value, based on the type of the cabin unit joined to the vehicle. Where the vehicle is able to offer a different service by replacing the cabin unit with another one, the controller can give appropriate notice, by setting the threshold value for each cabin unit.

Also, the controller may be characterized by comparing the acceleration and jerk of the vehicle with respective threshold values. Also, the controller may be characterized by using different manners of giving notice, depending on whether the acceleration exceeds its threshold value, or the jerk exceeds its threshold value. For example, the controller can let the occupant know what type of oscillations will be generated, by changing the content of the notice, between the case where the object is the acceleration (the rate of change of the speed), and the case where it is the jerk (the rate of change of the acceleration).

Also, the controller may be characterized by predicting the acceleration, by making a first prediction based on information obtained from sensors included in the vehicle, and making a second prediction based on the result of checking of position information of the vehicle against map data. By using both of data obtained by sensing, and data obtained from a road map, the controller can predict the acceleration with high accuracy.

Also, the controller may be characterized by obtaining data concerning the speed and the steering angle, from an automatic driving system included in the vehicle, and making the prediction based on the data. Where an automatic driving platform is installed on the vehicle, data concerning automatic driving, which is obtained from the automatic driving platform, can be utilized for prediction of change in the acceleration.

Also, the controller may be characterized by determining the threshold value, based on the type of the activity, and a condition of the occupant obtained by sensing the occupant. Also, the controller may be characterized by setting the threshold value to a larger value in the case where the occupant is not performing a given activity, than that in the case where the occupant is performing the given activity.

Even when a particular activity is performed in the vehicle cabin, the activity is not necessarily performed all the time. For example, in a vehicle in which an occupant is able to do physical training, the occupant may be at rest sometimes. Accordingly, the threshold value may be dynamically changed based on what the occupant is doing at present, in addition to the type of the activity. With this configuration, the number of times wasteful notices are given can be reduced. The sensing mentioned above may be performed by a sensor, or based on an image obtained by imaging the occupant.

Some embodiments of this disclosure will be described, based on the drawings. The configurations of the embodiments below are merely exemplary, and this disclosure is not limited to the configurations of the embodiments.

### First Embodiment

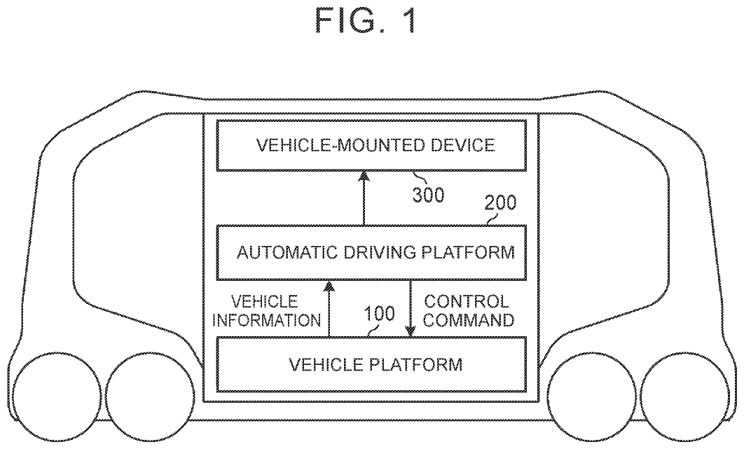

A vehicle system according to a first embodiment will be generally described with reference to FIG. 1. The vehicle system according to this embodiment includes a vehicle platform 100 that performs autonomous traveling based on given commands, an automatic driving platform 200 as an automatic driving system, and a vehicle-mounted device 300.

The vehicle platform 100 includes a computer (e.g., engine ECU (electronic control unit), etc.) that performs traveling control of the vehicle. The vehicle platform 100 operates based on control commands, and generates vehicle information. The control commands and the vehicle information are transmitted and received via a CAN (controller area network) frame that flows in an on-board network, for example. The automatic driving platform 200 includes a computer (e.g., automatic driving ECU) that performs automatic driving control of the vehicle. The automatic driving platform 200 may have means for sensing the vicinity of the vehicle, and means for generating a plan on traveling, based on the result of sensing. The vehicle-mounted device 300 provides information concerning oscillations of the vehicle to the occupant. The vehicle-mounted device 300 may be a device fixed to the vehicle, or may be a portable terminal.

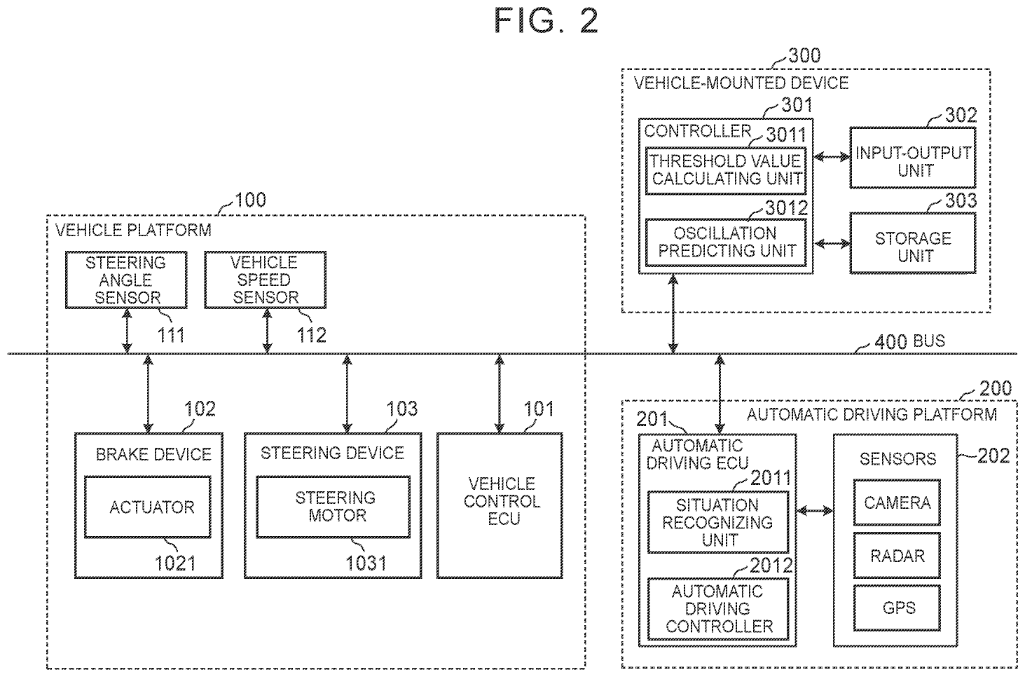

Next, constituent elements of the system will be described in detail. FIG. 2 is block diagram schematically showing one example of the configuration of the vehicle system shown in FIG. 1. The vehicle system includes the vehicle platform 100, automatic driving platform 200, and vehicle-mounted device 300, and the respective constituent elements are connected via a bus 400 such that the elements can communicate with each other.

The vehicle platform 100 has a vehicle control ECU 101, brake device 102, steering device 103, steering angle sensor 111, and vehicle speed sensor 112. While the vehicle in this embodiment has an engine, for example, the vehicle may be an electric vehicle. In this case, the engine ECU may be replaced with an ECU that manages power of the vehicle. The vehicle platform 100 may include ECU(s) and sensor(s) other than those illustrated in FIG. 2.

The vehicle control ECU 101 is a computer that controls constituent elements (e.g., engine-system components, powertrain-system components, brake-system components, electric-system components, body-system components, etc.) of the vehicle. The vehicle control ECU 101 may comprise a set of two or more computers. The vehicle control ECU 101 controls the rotational speed of the engine, by performing fuel injection control, for example. The vehicle control ECU 101 can control the engine speed, based on a control command (e.g., a command indicating the throttle opening) generated through operation (e.g., accelerator pedal operation) of the occupant, for example.

Also, where the vehicle is an electric vehicle, the vehicle control ECU 101 can control the rotational speed of a motor, by controlling the drive voltage or current, drive frequency, and so forth. In this case, too, the vehicle control ECU 101 can control the motor speed, based on a control command generated through operation of the occupant, as is the case with the internal-combustion vehicle. Also, the vehicle control ECU 101 can control regenerative current, based on a control command indicating the force on the brake pedal, or the degree of regenerative brake. Where the vehicle is a hybrid vehicle, the vehicle control ECU 101 may perform both control on the engine and control on the motor.

In addition, the vehicle control ECU 101 controls an actuator 1021 included in the brake device 102 that will be described later, so as to control braking force produced by machine brake. For example, the vehicle control ECU 101 drives the actuator 1021 based on a control command (e.g., a command representing the force on the brake pedal) generated through operation (such as brake pedal operation) of the occupant, so as to control the brake hydraulic pressure.

Also, the vehicle control ECU 101 controls a steering motor 1031 included in the steering device 103 that will be described later, so as to control the steering angle or the angle (turn angle) of steered wheels. The vehicle control ECU 101 controls the steering angle of the vehicle, by driving the steering motor 1031 based on a control command (e.g., a command representing the steering angle) generated through operation (such as steering operation) of the occupant, for example.

The control command may be generated in the vehicle platform 100 based on the operation of the occupant, or may be generated outside the vehicle platform 100 (for example, by the automatic driving platform 200).

The brake device 102 is a machine brake system included in the vehicle. The brake device 102 includes an interface (e.g., brake pedal), actuator 1021, hydraulic system, brake cylinders, and so forth. The actuator 1021 is a means for controlling the hydraulic pressure in the brake system. The actuator 1021, which receives a command from the vehicle control ECU 101, controls the brake hydraulic pressure, so as to secure braking force produced by the machine brake.

The steering device 103 is a steering system included in the vehicle. The steering device 103 includes an interface (e.g., steering wheel), steering motor 1031, gear box, steering column, and so forth. The steering motor 1031 is a means for assisting in steering operation. The steering motor 1031, which receives a command from the vehicle control ECU 101, is driven, so that force required for steering operation can be reduced. Also, the steering motor 1031 is driven, so that steering operation can be performed automatically, namely, without depending on operation of the occupant.

The steering angle sensor 111 detects the steering angle obtained by the steering operation. Detection values obtained by the steering angle sensor 111 are transmitted as needed to the vehicle control ECU 101. While a numerical value directly representing the turn angle of a tire is used as the steering angle in this embodiment, a value indirectly representing the turn angle of the tire may also be used. The vehicle speed sensor 112 detects the speed of the vehicle. Detection values obtained by the vehicle speed sensor 112 are transmitted as needed to the vehicle control ECU 101.

Next, the automatic driving platform 200 will be described. The automatic driving platform 200 is a system that performs sensing of the vicinity of the vehicle, generates a plan on traveling, based on the result of sensing, and issues control commands to the vehicle platform 100 according to the plan. The automatic driving platform 200 may be developed by a manufacturer or vendor different from that of the vehicle platform 100. The automatic driving platform 200 has an automatic driving ECU 201, and sensors 202.

The automatic driving ECU 201 is a computer that controls the vehicle by making determinations on automatic driving, based on data obtained from the sensors 202 that will be described later, and controls the vehicle by communicating with the vehicle platform 100. The automatic driving ECU 201 comprises a central processing unit (CPU), for example. The automatic driving ECU 201 has two function modules, i.e., a situation recognizing unit 2011 and an automatic driving controller 2012. Each of the function modules may be implemented by causing the CPU to execute a program stored in a storing means, such as a read-only memory (ROM).

The situation recognizing unit 2011 detects the environment around the vehicle, based on data obtained by sensors included in the set of sensors 202 that will be described later. Objects to be detected include, for example, the number and positions of lanes, the number and positions of vehicles present around the self-vehicle, the number and positions of obstacles (e.g., pedestrians, bicycles, structures, buildings, etc.) present around the self-vehicle, structure of the road, road signs, and so forth, but are not limited to these. Anything may be an object to be detected, provided that it is needed for autonomous traveling. The data (which will be called “environment data”) concerning the environment, which is detected by the situation recognizing unit 2011, is transmitted to the automatic driving controller 2012 that will be described below.

The automatic driving controller 2012 controls traveling of the self-vehicle, using the environment data generated by the situation recognizing unit 2011. For example, the automatic driving controller 2012 generates a traveling path of the self-vehicle based on the environment data, and determines the acceleration/deceleration and steering angle of the vehicle, so that the vehicle travels along the traveling path. The information determined by the automatic driving controller 2012 is transmitted to the vehicle platform 100 (vehicle control ECU 101). A known method may be employed, as a method for causing the vehicle to travel autonomously.

In this embodiment, the automatic driving controller 2012 generates a command (acceleration/deceleration command) concerning the acceleration or deceleration of the vehicle, and a command (steering angle command) concerning the steering angle of the vehicle, and sends the commands to the vehicle platform 100. Further, the automatic driving controller 2012 sends the information concerning the acceleration/deceleration and steering, and information concerning a traveling route, to the vehicle-mounted device 300, as will be described later.

The sensors 202 are means for sensing the vicinity of the vehicle, and typically include monocular camera, stereo camera, radar, LIDAR (Laser Imaging Detection and Ranging), laser scanner, and so forth. The sensors 202 may include means (such as a GPS (global positioning system) module) for obtaining the current position of the vehicle, in addition to the means for sensing the vicinity of the vehicle. Data obtained by sensors included in the set of sensors 202 is transmitted as needed to the automatic driving ECU 201 (situation recognizing unit 2011). Further, the data obtained by the sensors is also transmitted to the vehicle-mounted device 300, and used for prediction of oscillations, as will be described later.

The vehicle-mounted device 300 determines whether the vehicle will oscillate to an extent exceeding a threshold value, within a predetermined time, based on data obtained from the automatic driving platform 200, and gives notice to the occupant based on the result of determination. More specifically, the vehicle-mounted device 300 predicts the acceleration and jerk applied to the vehicle, based on the obtained data, and gives notice to the occupant when the predicted acceleration or jerk exceeds a threshold value. The vehicle-mounted device 300 includes a controller 301, input-output unit 302, and storage unit 303. While only the acceleration may be indicated as an example of objects to be determined in the description below, the jerk may also be included in the objects to be determined.

The vehicle-mounted device 300 may comprise a general-purpose computer. Namely, the vehicle-mounted device 300 may be configured as a computer having a processor, such as CPU or graphics processing unit (GPU), main storage device, such as a random access memory (RAM) or ROM, and auxiliary storage device, such as an erasable programmable read-only memory (EPROM), hard disc drive, or removable medium. The removable medium may be, for example, a USB memory, or a disc recording medium, such as CD or DVD. Operating system (OS), various programs, various tables, etc. are stored in the auxiliary storage device. In operation, a program stored in the auxiliary storage device is loaded into a work area of the main storage device, and executed, and each constituent part, etc. is controlled through execution of the program, so that each function that matches a certain purpose can be implemented, as will be described later. In this connection, a part or the whole of the functions may be implemented by a hardware circuit, such as ASIC (Application Specific Integrated Circuit) or FPGA (Field Programmable Gate Array).

The controller 301 is a computing device that governs control performed by the vehicle-mounted device 300. The controller 301 may be realized by an arithmetic processing unit, such as CPU. The controller 301 has two function modules, i.e., a threshold value calculating unit 3011 and an oscillation predicting unit 3012. Each of the function modules may be realized by causing the CPU to execute a stored program.

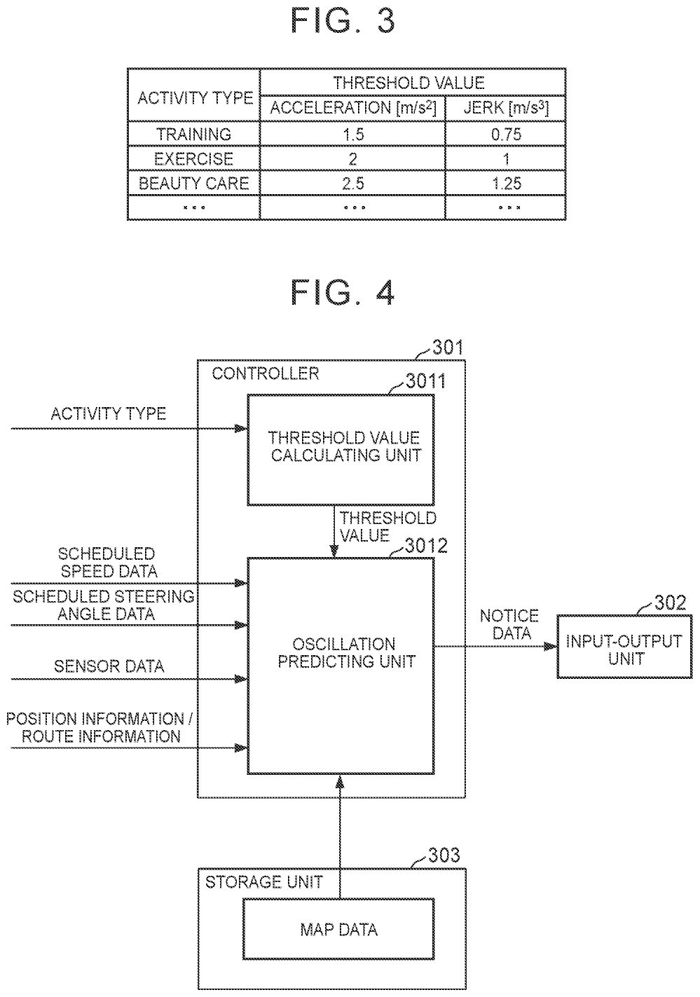

The threshold value calculating unit 3011 determines threshold values of the acceleration (and the jerk) used when giving notice to the occupant. More specifically, the threshold value calculating unit 3011 obtains information concerning the type of the activity (which will be called “activity type”) of the occupant, and determines the threshold value of the acceleration and the threshold value of the jerk, respectively, based on the information. FIG. 3 shows an example of data (threshold table) used by the threshold value calculating unit 3011. In this example, when training as one type of activity is conducted in the vehicle, and an acceleration equal to or larger than 1.5 m/s² or a jerk equal to or larger than 0.75 m/s³ is predicted, the acceleration or jerk becomes an object based on which notice is given to the occupant.

The oscillation predicting unit 3012 determines whether the acceleration or jerk that exceeds its threshold value will be applied to the vehicle, within a predetermined time (e.g., within three seconds, or five seconds), based on the data obtained from the automatic driving platform 200. More specifically, the oscillation predicting unit 3012 predicts the acceleration and jerk applied to the vehicle, based on the acceleration and steering angle determined by the automatic driving platform 200, sensor data obtained by the automatic driving platform 200, etc. Also, the oscillation predicting unit 3012 determines that notice is given to the occupant when either of the predicted acceleration and jerk, when compared with the determined threshold values, exceeds the corresponding threshold value.

The input-output unit 302 is an interface used for input and output of information. The input-output unit 302 has a display device or a touch panel, for example. The input-output unit 302 may include a keyboard, camera, short-range communication means, touch screen, or the like.

The storage unit 303 includes a main storage device and an auxiliary storage device. The main storage device is a memory in which a program executed by the controller 301 and data used in the control program are deployed. The auxiliary storage unit is a device in which the program executed by the controller 301 and data (e.g., threshold table) used in the control program are stored. In this embodiment, the storage unit 303 stores data (map data) concerning roads on which the vehicle can travel.

FIG. 4 is a view showing data input to and output from the controller 301. The threshold value calculating unit 3011 obtains data concerning the type (activity type) of the activity performed in the vehicle cabin. The data may be obtained from the occupant of the vehicle via the input-output unit 302. Namely, the occupant of the vehicle may enter the activity type into the vehicle-mounted device 300 each time he/she gets on board. Also, where the vehicle cabin is of a module type, and is replaceable, data indicating how the vehicle cabin is used (the type of the vehicle cabin) may be obtained from a cabin unit connected to the vehicle. The threshold value calculated by the threshold value calculating unit 3011 is transmitted to the oscillation predicting unit 3012.

The oscillation predicting unit 3012 predicts the acceleration, etc. of the vehicle based on three types of data. A first type of data is concerned with the speed and steering angle generated by the automatic driving platform 200. In this embodiment, the automatic driving platform 200 sends data concerning changes in the speed and steering angle, which are scheduled to appear within a predetermined time, to the vehicle-mounted device 300, apart from the acceleration/deceleration command and steering angle command transmitted to the vehicle platform 100. More specifically, the automatic driving platform 200 sends data (scheduled speed data) representing scheduled changes in the speed within the predetermined time, and data (scheduled steering angle data) representing scheduled changes in the steering angle within the predetermined time. The oscillation predicting unit 3012 computes (the actual) movement of the vehicle, based on the received data, and predicts whether an acceleration or jerk, which exceeds its threshold value, will be applied to the vehicle within the predetermined time.

A second type of data is sensor data obtained by the automatic driving platform 200 (the set of sensors 202). In this embodiment, the automatic driving platform 200 sends results obtained by sensing obstacles and other vehicles, to the vehicle-mounted device 300, in real time, and the oscillation predicting unit 3012 predicts whether the acceleration or jerk that exceeds its threshold value will be applied to the vehicle within the predetermined time, based on the data thus received. The sensor data may be obtained by integrating two or more sensing results.

A third type of data is map data. More specifically, the oscillation predicting unit 3012 predicts whether the acceleration or jerk that exceeds its threshold value will be applied to the vehicle within the predetermined time, based on information (route information) concerning the traveling route transmitted from the automatic driving ECU 201, position information transmitted from the set of sensors 202, and map data stored in the storage unit 303. The acceleration and the jerk may be predicted based on the curvature of a curve, or the presence or absence of a right/left turn in an intersection, for example.

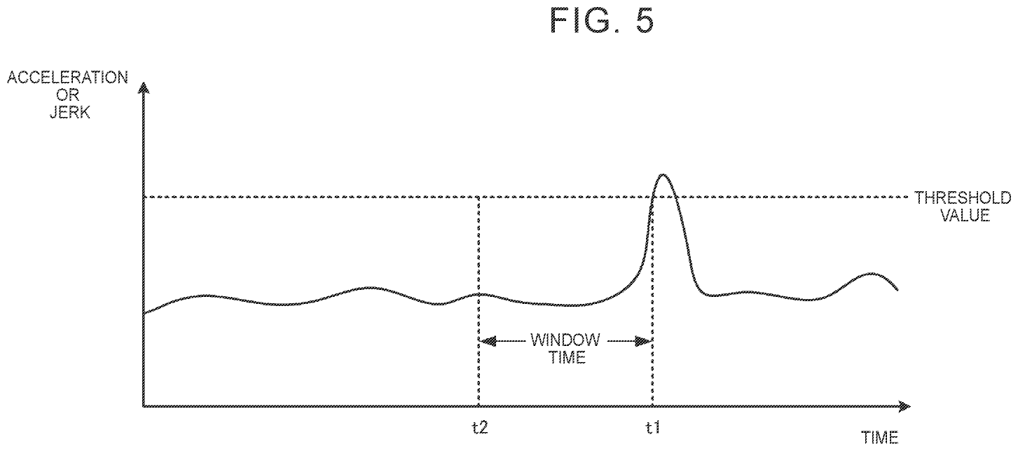

When the oscillation predicting unit 3012 predicts that the acceleration or jerk that exceeds its threshold value will appear within the predetermined time, it outputs data (notice data) for giving notice to the occupant, to the input-output unit 302. Thus, the input-output unit 302 informs the occupant, via voice, or the like, that oscillations will take place within the predetermined time. FIG. 5 is a view indicating the relationship between time and acceleration. When the oscillation predicting unit 3012 predicts that the acceleration (jerk) that exceeds the threshold value will be applied to the vehicle at time t1, notice is given to the occupant at a point in time (time t2 in this example) prior to time t1 by a given window time. The window time is preferably a period of time that enables the occupant to deal with oscillations, for example. When the window time is not a fixed value, the occupant of the vehicle may be informed of time t1, by way of countdown, for example.

Further, the content of the notice given to the occupant may be changed, depending on which of the acceleration and the jerk exceeds the threshold value. For example, the occupant may be informed of oscillations in one direction when the acceleration exceeds the threshold value, and may be informed of oscillations in different directions when the jerk exceeds the threshold value.

The input-output unit 302 may simply inform the occupant of only the possibility of occurrence of oscillations, or may also inform the occupant of its period. For example, the vehicle may oscillate only for a moment when it passes a step, and centrifugal force may be applied to the vehicle over a certain period of time when the vehicle goes through a sharp corner or curve. Thus, the notice data may include information concerning the duration of the acceleration (jerk), and the notice including the information may be given to the occupant via the input-output unit 302. Also, the content of the notice may be changed, depending on which of the acceleration and the jerk exceeds the threshold value. For example, the occupant may be warned more clearly when the jerk exceeds the threshold value, as compared with the case where the acceleration exceeds the threshold value.

While the direction in which the acceleration is applied is not specified in the above example, the occupant may be informed of the direction at the same time when the direction in which the acceleration is applied can be predicted. For example, when the vehicle approaches a left curve, the occupant may be informed of a possibility of swaying in the right direction. Further, in the data of FIG. 3, a threshold value may be provided for each axis. For example, a threshold value may be provided for each of the X-axis, Y-axis, and Z-axis, and prediction may be made for each axis. When the acceleration or jerk on any of the axes exceeds the threshold value, the occupant may be informed of the result of prediction.

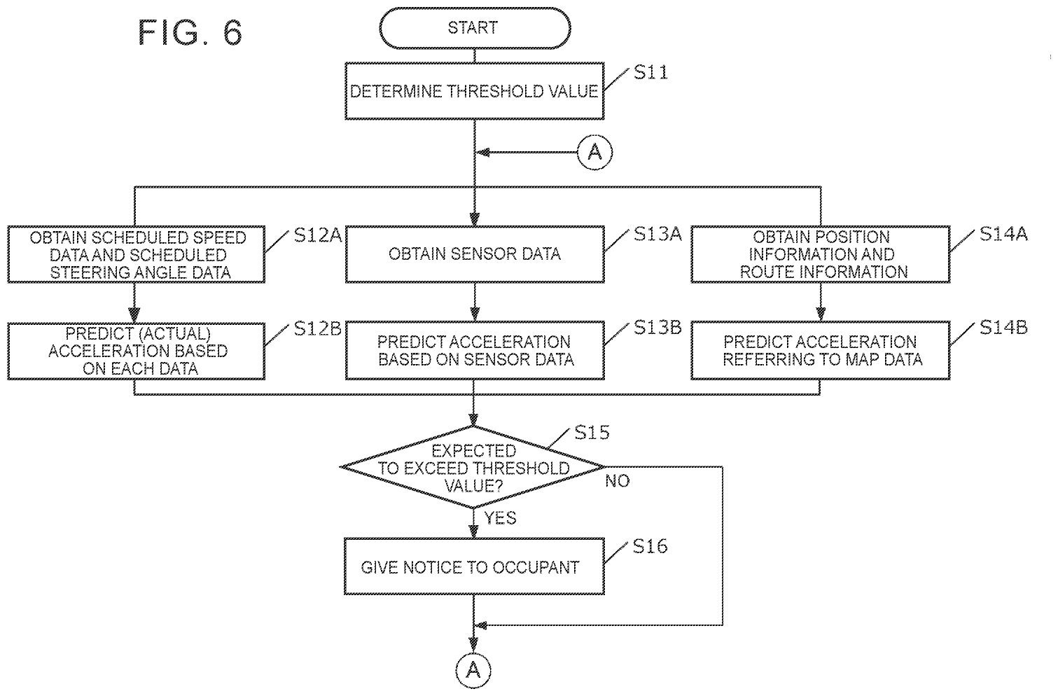

FIG. 6 is a flowchart of a control routine performed by the vehicle-mounted device 300 (the controller 301). The control routine is executed at the time when the vehicle starts traveling. Initially, in step S11, the threshold value calculating unit 3011 determines the threshold value of the acceleration (jerk) based on the activity type. As described above, the threshold value may be determined based on the data stored in the storage unit 303. The threshold value calculating unit 3011 may obtain the activity type via the input-output unit 302, or may obtain it by communicating with the cabin unit.

Steps S12A to S12B, steps S13A to S13B, and steps S14A to S14B are executed in parallel. In step S12A, the controller 301 obtains scheduled speed data and scheduled steering angle data from the automatic driving platform 200. In step S12B, the controller 301 predicts change of the acceleration within a predetermined time, based on the data obtained in step S12A. In step S13A, the controller 301 obtains various sensor data from the automatic driving platform 200. In step S13B, the controller 301 predicts change of the acceleration within the predetermined time, based on the data obtained in step S13A. In step S14A, the controller 301 obtains the position information and route information from the automatic driving platform 200. Then, in step S14B, the controller 301 predicts change of the acceleration within the predetermined time, referring to the map data stored in the storage unit 303.

In step S15, the controller 301 determines whether the acceleration or jerk is expected to exceed its threshold value, in any of the three types of predicting operation. When the controller 301 determines that the acceleration or jerk will exceed the threshold value, it proceeds to step S16, and gives notice to the occupant. If not, the same determining operation is repeated.

As described above, the vehicle-mounted device 300 according to the first embodiment calculates the threshold value of the acceleration or jerk applied to the vehicle, based on the type of the activity performed in the vehicle cabin. With this configuration, the vehicle-mounted device 300 can dynamically determine whether notice is given to the occupant, according to the level where caution or attention is needed; thus, sufficient levels of the safety and convenience can be both achieved.

### Second Embodiment

In the first embodiment, the threshold value is uniformly set, based on the type of the activity performed in the vehicle cabin. On the other hand, in a second embodiment, the threshold value is further changed, according to a condition of the occupant in the vehicle cabin.

When the activity performed in the vehicle cabin is training, for example, the threshold value that should be adopted differs between the case where the occupant is carrying a heavy load, and the case where the occupant is at rest. Also, when the activity performed in the vehicle cabin is a haircut, the threshold value differs depending on whether a hairdresser is holding a pair of scissors or not. To cope with the situations, the vehicle-mounted device 300 according to the second embodiment dynamically changes the threshold value, based on the result of sensing of occupant's conditions.

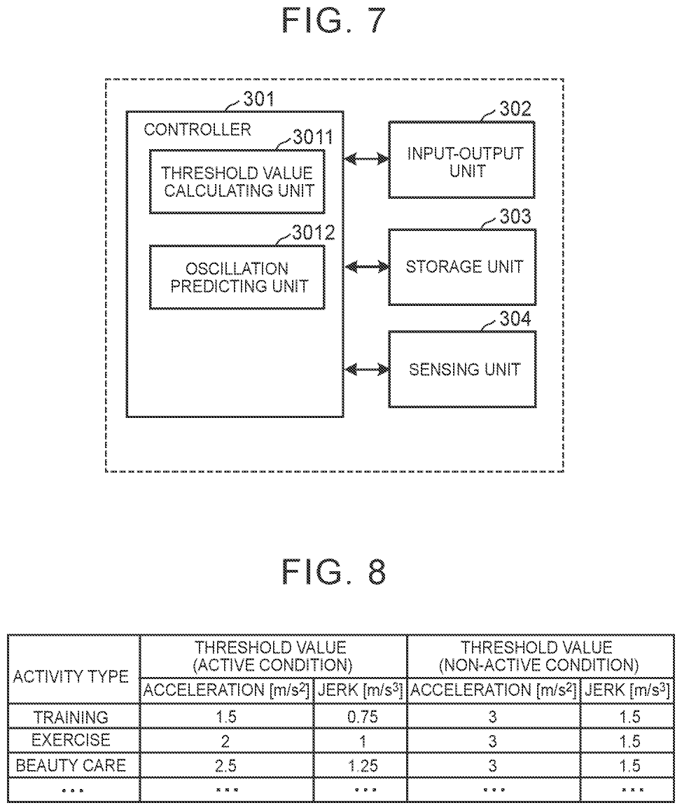

FIG. 7 shows the configuration of the vehicle-mounted device 300 according to the second embodiment. Unlike the vehicle-mounted device 300 according to the first embodiment, the vehicle-mounted device 300 according to the second embodiment further has a means (sensing unit 304) for sensing a condition of the occupant. The sensing unit 304 obtains a condition of the occupant. More specifically, the sensing unit 304 determines which of two or more conditions defined for each activity type to which the current condition of the occupant corresponds.

For example, where the activity type is training, a condition (active condition) in which a load is applied to the occupant's muscles, or the posture of the occupant is unstable, and a conditions (non-active conditions) in which no load is applied to the muscles or the posture is stable, are defined, and the sensing unit 304 determines which of the conditions the occupant is placed in. The determination can be made using a machine learning model, based on captured images of the occupant. Then, the threshold value calculating unit 3011 determines the threshold value, using the condition thus determined. FIG. 8 is an example of a threshold table for use in the second embodiment.

While the two types of conditions, i.e., active condition and non-active condition, are defined in this example, the conditions may be classified into three or more types. Where there are three or more types of conditions, different threshold values may be set for the respective types. While the threshold value may be determined using a table, it may also be determined by calculation. For example, default threshold values as indicated in FIG. 3 by way of example may be corrected, based on the condition of the occupant. The threshold value may be determined by any method, provided that the threshold value can be set to a larger value when the occupant is not performing a given activity, than that of the case where the occupant is performing the given activity. Modified Examples

The illustrated embodiments are mere examples, and the disclosure may be embodied by changing the embodiments as appropriate without departing from its principle. For example, processes or means described in this disclosure may be freely combined and carried out, unless the combination gives rise to any technical inconsistency.

While the vehicle-mounted device 300 predicts oscillations of the vehicle, based on data obtained from the automatic driving platform 200, as described above with regard to the embodiments, the automatic driving platform 200 is not an essential constituent element. For example, the vehicle-mounted device 300 may be equipped with means for sensing. Also, the vehicle-mounted device 300 may be a device fixed outside the vehicle.

A process or operation described as being performed by a single device may be shared and executed by two or more devices. Alternatively, a process or operation described as being performed by different devices may be executed by a single device. In a computer system, what hardware configuration (server configuration) implements each function can be flexibly changed.

This disclosure can be practiced by supplying a computer program into which the functions described in the above embodiments are installed, to a computer, and causing one or more processors included in the computer to read and execute the program. The computer program may be provided to the computer by means of a non-temporary, computer-readable storage medium that can be connected to a system bus of the computer, or may be provided to the computer via a network. The non-temporary computer-readable storage medium may be selected from, for example, any given type of disc, such as a magnetic disc (e.g., a floppy (registered trademark) disc, or hard disc drive (HDD)), or an optical disc (e.g., CD-ROM, DVD, or blue-ray disc), ROM, RAM, EPROM, electrically erasable programmable read-only memory (EEPROM), magnetic card, flash memory, optical card, and any given type of medium suitable for storing electronic commands.

What is claimed is:

1. An information processing device that provides information to an occupant who performs a given activity in a vehicle, the information processing device comprising a controller configured to:
predict an acceleration applied to the vehicle within a predetermined period;
give notice to the occupant when a value related to the predicted acceleration exceeds a threshold value; and
determine the threshold value based on a type of the activity performed in the vehicle.

2. The information processing device according to claim 1, further comprising a storage unit configured to store the type of the activity and the threshold value such that the type of the activity is associated with the threshold value.

3. The information processing device according to claim 1, wherein:
the vehicle is adapted to travel with a cabin unit joined to the vehicle; and
the controller is configured to determine the threshold value, based on the type of the activity of the occupant performed in the cabin unit joined to the vehicle.

4. The information processing device according to claim 3, wherein the controller is configured to determine the threshold value, based on a type of the cabin unit joined to the vehicle.

5. The information processing device according to claim 1, wherein the controller is configured to compare the acceleration and a jerk of the vehicle with a first threshold value and a second threshold value, respectively, each of the first threshold value and the second threshold value being the threshold value.

6. The information processing device according to claim 5, wherein the controller is configured to give notice to the occupant by different methods, depending on whether the acceleration exceeds the first threshold value or the jerk exceeds the second threshold value.

7. The information processing device according to claim 1, wherein the controller is configured to predict the acceleration, by making a first prediction based on information obtained from a sensor included in the vehicle, and making a second prediction based on a result of matching of position information of the vehicle against map data.

8. The information processing device according to claim 1, wherein the controller is configured to obtain data concerning a speed and a steering angle, from an automatic driving system included in the vehicle, and predicts the acceleration based on the data.

9. The information processing device according to claim 1, wherein the controller is configured to determine the threshold value, based on the type of the activity, and a condition of the occupant obtained by sensing the occupant.

10. The information processing device according to claim 9, wherein the controller is configured to set the threshold value to a larger value in a case where the occupant is not performing the given activity, than that in a case where the occupant is performing the given activity.

11. An information processing method performed by an information processing device that provides information to an occupant who performs a given activity in a vehicle, the information processing method comprising:
predicting an acceleration applied to the vehicle within a predetermined period;
giving notice to the occupant when a value related to the predicted acceleration exceeds a threshold value; and
determining the threshold value based on a type of the activity performed in the vehicle.

12. The information processing method according to claim 11, further comprising obtaining data in which the type of the activity is associated with the threshold value.

13. The information processing method according to claim 11, wherein:
the vehicle is adapted to travel with a cabin unit joined to the vehicle; and
the threshold value is determined, based on the type of the activity of the occupant performed in the cabin unit joined to the vehicle.

14. The information processing method according to claim 13, wherein the threshold value is determined, based on a type of the cabin unit joined to the vehicle.

15. The information processing method according to claim 11, wherein the acceleration and a jerk of the vehicle are compared with a first threshold value and a second threshold value, respectively, each of the first threshold value and the second threshold value being the threshold value.

16. The information processing method according to claim 15, wherein the notice is given to the occupant by different methods, depending on whether the acceleration exceeds the first threshold value or the jerk exceeds the second threshold value.

17. The information processing method according to claim 11, wherein the acceleration is predicted by making a first prediction based on information obtained from a sensor included in the vehicle, and making a second prediction based on a result of matching of position information of the vehicle against map data.

18. The information processing method according to claim 11, wherein data concerning a speed and a steering angle is obtained from an automatic driving system included in the vehicle, and the acceleration is predicted based on the data.

19. The information processing method according to claim 11, wherein the threshold value is determined, based on the type of the activity, and a condition of the occupant obtained by sensing the occupant.

20. The information processing method according to claim 19, wherein the threshold value is set to a larger value in a case where the occupant is not performing the given activity, than that in a case where the occupant is performing the given activity.

21. A program that causes a computer to execute the information processing method according to claim 11.
